(19) United States
(12) Patent Application Publication
(10) Pub. No.: US 2015/0289538 A1
(43) Pub. Date: Oct. 15, 2015

(54) METHOD OF PRODUCING FROZEN CONFECTION PRODUCT

(71) Applicant: NESTEC S.A., Vevey (CH)

(72) Inventors: Madhavi Ummadi, Bakersfield, CA (US); Sinan Imer, Bakersfield, CA (US)

(21) Appl. No.: 14/439,702

(22) PCT Filed: Oct. 17, 2013
(86) PCT No.: PCT/EP13/71723

§ 371 Date: Apr. 30, 2015

(30) Foreign Application Priority Data
Oct. 31, 2012 (US) PCT/US2012/062811

(51) Int. Cl. A23G 9/04; A23G 9/46; A23C 9/123; A23G 9/40

(52) U.S. Cl. CPC A23G 9/04; A23G 9/40; A23G 9/46; A23C 9/123

(57) ABSTRACT

The present invention relates to a method of producing a frozen confection product with improved freeze-thaw stability. In particular, the invention relates to a method comprising a post pasteurization acidification step. The present invention also relates to products obtainable by such a method.

### TECHNICAL FIELD OF THE INVENTION

The present invention relates to a method of producing a frozen confection product with improved freeze-thaw stability.

In particular, the invention relates to a method comprising a post pasteurization acidification step. The present invention also relates to products obtainable by such a method.

### BACKGROUND OF THE INVENTION

In frozen confection products such as for example frozen yoghurt, a freeze-thaw cycle generally leads to deterioration in mouth feel. Ice crystals are formed and the creamy texture is lost.

The ability to withstand freeze-thaw cycle without deterioration in texture is of great importance in the frozen confection product industry. From a producer point of view, lack of freeze-thaw stability means that temperatures along the entire distribution chain must be strictly controlled and maintained without variations. This is very energy-consuming and costly. If the product is subject to variations in temperature at some point in the distribution chain, an inferior product will be delivered. This is negative for producer, retailer and consumer.

On a consumer level, freeze-thaw stability is desirable as this affords the consumer flexibility in how much and when the product may be consumed without detracting from the quality of the product.

Thus, improved freeze-thaw stability of frozen confection products are sought after by both the producers and consumers of frozen confection products.

Further, there is increasing demand from the consumer for products which are natural. Products which contain artificial emulsifiers and stabilisers are perceived negatively by consumers, and therefore alternative solutions are sought after. However, most confection products with creamy texture currently on the market contain such emulsifiers and/or stabilizers.

In the same manner, there is a demand from consumers for low fat confection products as these are perceived to have health benefits. Unfortunately, low fat alternatives tend to rely even more than higher fat alternatives on emulsifiers and stabilizers to attain a pleasant mouth texture.

In the prior art the use of egg yolk as an emulsifier in frozen desserts is also described. However, egg adds an allergen into the products and into the manufacturing system which is difficult to wash out. Allergens in food products are therefore preferably be excluded.

WO2012/016854 describes a frozen confection product comprising a partially coagulated protein network. Said frozen confection product displays a stability which is improved over the conventional frozen confection products. Said products also display a satisfactory mouth feel.

Nonetheless, new and further improved methods for making frozen confection products are sought after, particularly where the frozen confection products produced display improved freeze-thaw stability.

There is also a desire in the market for products which are “better for you”. Such products should comprise a minimum of artificial or non-natural ingredients.

Furthermore, there is a desire for products comprising lower fat content. However, the consumer is unwilling to compromise on taste and texture in the frozen confection products.

Hence, confection products which have improved freeze-thaw stability, as well as confection products which lack or have lower levels of stabilisers and emulsifiers but which have a pleasurable texture are sought after. Further, production methods for producing confectionaries with increased procedural economy are desirable.

### SUMMARY OF THE INVENTION

Thus, an object of the present invention relates to providing a method of producing a frozen confection product with improved freeze-thaw stability.

In addition, it is an object of the present invention to provide a method to produce a frozen confection product which may be consumed when thawed, without or with only minimal loss of appealing texture.

A further object of the present invention is to provide a method to produce confection products which comprise fewer or even no artificial ingredients such as artificial stabilisers and/or emulsifiers.

A still further object of the present invention is to provide a method to produce a confection product with low fat or fat-free, yet which has an appealing texture.

The producer of frozen confection products seeks to minimize the vulnerability of the products to heat shock, because this will reduce the cost of maintaining strict low temperatures in the distribution chain.

The provision of a method for making freeze-thaw stable frozen confection of the invention, and the products obtainable by the method, offers a solution to the producer.

The inventors of the present invention have surprisingly found that applying a post-pasteurization acidification step in a method for producing frozen confection product leads to a frozen confection product with very high freeze-thaw stability.

The post-pasteurization acidification step leads to coagulation of the protein and formation of an essentially completely coagulated protein network. The essentially completely coagulated protein network has the effect of producing a very stable frozen product, such that even upon freeze-thawing there is little or no syneresis evident. This leads to a unique product which may be produced frozen but which may also be thawed and consumed after thawing with little to no deterioration of texture.

The term “essentially completely coagulated” means that over 60% of the proteins are coagulated, such as at least 65%, at least 70%, at least 75%, at least 80%, at least 85%, at least 90%.

Without wishing to be bound by theory, it is thought that the protein network binds and holds water, reducing the formation of large ice crystals. By protein aggregation the large milk protein structure in an ingredient mix is broken into smaller proteins, i.e. the proteins are un-folded. These unfolded proteins have the ability to increase the water holding capacity and form a unique 3-D network. Furthermore, protein aggregates form a network that is suspected to entrap water and fat globules and increases mix viscosity to create a uniquely smooth, creamy texture that mimics the presence of higher fat levels.

Thus, one aspect of the invention relates to a method of producing a confection product comprising the steps of

a) providing an ingredient mix comprising one or more proteins;
b) homogenizing the ingredient mix;
c) pasteurising the ingredient mix;
d) acidification of the pasteurized ingredient mix to adjust the pH to a pH in the range from 4.0 to 6.5,
e) freezing the pasteurized and acidified mix to form a frozen confection product;
f) optionally hardening the product from e;
g) optionally thawing the product from f) to form a thawed confection product.

The product of the invention may be produced frozen and served when thawed without deleterious effects on the taste or texture of the confection product.

Another aspect of the present invention relates to frozen or thawed confection product obtainable by the method of the invention.

The method of the invention provides products with improved stability. This reduces the need for stabiliser systems and emulsifiers, which can even be omitted. This meets the consumer's desire for confection products with little or no artificial ingredients.

Yet another aspect of the invention is to provide a freeze-thaw stable frozen confection product with reduced fat levels. The post-pasteurization step in the method of the invention leads to production of frozen confection products with very high stability. Thus, low or non-fat products may be produced which retain a pleasurable texture.

In general, the various aspects of the present invention may be combined and coupled in any way possible within the scope of the invention. These and other aspects, features and/or advantages of the invention will be apparent from and elucidated with reference to the embodiments described hereinafter.

### BRIEF DESCRIPTION OF THE FIGURES

FIG. 1 shows the particle size distribution in products of methods comprising only pre-pasteurization (Control, black line) vs pre-+post pasteurization acidification (Frozen yoghurt, broken line).

FIG. 2 shows microscope image of networks, Control.

FIG. 3 shows microscope image of networks, Frozen Yoghurt.

FIG. 4 is a flowchart over exemplary methods of the invention.

### DETAILED DESCRIPTION OF THE INVENTION

### Definitions

Prior to discussing the present invention in further detail, the following terms and conventions will first be defined.

In the context of the present invention, mentioned percentages are weight/weight percentages unless otherwise stated.

The term “and/or” used in the context of the “X and/or Y” should be interpreted as “X”, or “Y”, or “X and Y”.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 1 to 8, from 3 to 7, from 4 to 9, from 3.6 to 4.6, from 3.5 to 9.9, and so forth.

All references to singular characteristics or limitations of the present invention shall include the corresponding plural characteristic or limitation, and vice versa, unless otherwise specified or clearly implied to the contrary by the context in which the reference is made.

Unless defined otherwise, all technical and scientific terms used herein have the same meaning as commonly understood by one of ordinary skill in the art (e.g. in frozen confection product manufacture). Definitions and descriptions of various terms and techniques used in frozen confection product manufacture are found in ice Cream, 6th Edition, Robert T Marshall, H. Douglas Goff and Richard W Hartel (2003), Kluwer Academic/Plenum Publishers.

Milk-solids-nonfat (MSNF) consists of the protein, carbohydrate (lactose) and ash (minerals) in a dairy product.

### Method

One aspect of the present invention relates to a method of producing a frozen or thawed confection product. The method leads to an essentially complete coagulation of the proteins, and thus to improved stability, higher viscosity and improve freeze-thaw stability of the product.

WO2012/016854 describes employing a pre-pasteurization acidification in order to obtain a creamier and more desired frozen dairy dessert texture. Such products were shown to have improved shelf life and increased viscosity.

However, WO2012/016854 indicates that the combination of heat and acid is necessary for achieving the coagulation. Due to the fact that pasteurizing machines have limits for how high viscosities that can be treated, there is also a limit on how high a viscosity that can be achieved using pre-pasteurization acidification.

It was surprisingly found by the inventors that acidification after pasteurization could also cause increased viscosity, i.e. increase protein coagulation, and lead to formation of an essentially completely coagulated protein network.

Previously, heat (e.g. from the pasteurization process) was believed to be necessary in combination with acidification to produce the coagulated networks which give the stability. However, the inventors have shown that the formation of networks takes place even without heat.

Post-pasteurization acidification does not require heat and an acidifying agent can be added to e.g. cold ingredient mix. Thus, the post-acidification step may be performed on the ingredient mix without heat.

The protein network formed is different from that produced by the methods of WO2012016854, as can be seen from the Figures. The network of the present invention is more extensive.

An embodiment the invention relates to a method of producing a confection product, comprising the steps of

a) providing an ingredient mix comprising one or more proteins;
b) homogenizing the ingredient mix;
c) pasteurising the ingredient mix;
d) acidification of the pasteurized ingredient mix to adjust the pH to a pH in the range from 4.0 to 6.5, preferably 4.6 to 5.0
e) freezing the pasteurized and acidified mix to form a frozen confection product;
f) optionally hardening the product from e;
g) optionally thawing the product from f) to form a thawed confection product.

### Pre-Pasteurization Acidification

In a preferred embodiment, a method of the invention further comprises a step of acidification of the mix before pasteurization in step c), in particular adjusting the pH to a pH in the range from 5.0 to 6.5, such as 5.0 to 6.2, such as from 5.0 to 6.0, for example 5.0 to 5.8, for example from 5.0 to 5.5. In one embodiment the pH is adjusted to a pH in the range from 6.1 to 6.4. Thus, this embodiment comprises both pre- and post-pasteurization acidification.

In an example of a preferred embodiment, a method of the invention comprises the steps of

a) providing an ingredient mix comprising one or more proteins;
b) homogenizing the ingredient mix;
c) pasteurising the ingredient mix;
d) acidification of the pasteurized ingredient mix to adjust the pH to a pH in the range from 4.0 to 6.5, preferably 4.6 to 5.0;
e) freezing the pasteurized and acidified mix to form a frozen confection product;
f) optionally hardening the product from e;
g) optionally thawing the product from f) to form a thawed confection product; and further comprising acidification of the mix before pasteurization in step c), in particular adjusting the pH to a pH in the range from 5.0 to 6.5, preferably 5.0 to 6.2.

In an example of a further preferred embodiment, a method according to the invention comprises post-pasteurization acidification, but does not comprise pre-pasteurization acidification.

### Confection Product

In the context of the present invention the term “confection product” means a food product which is typically sweet and/or flavoured, and typically having a creamy or smooth texture and an appealing appearance. Such food products may also be referred to as “confections”, “confectionery products” or “desserts” and these terms may be used interchangeably.

Methods of the invention may be used to produce frozen and/or thawed confection products. In the context of this application, references to a frozen confection product of the invention are thus also taken to include the thawed embodiment, unless otherwise specified.

A frozen confection product has a temperature of below 0° C. The invention also relates to a frozen confection product once thawed. Thus, the thawed confection product has a temperature of 0° C. or above. Preferably the thawed confection product is served chilled, i.e. it has a temperature below 20° C.

In an embodiment of the invention, the confection product may be selected from the group of dessert, cultured dessert, dairy dessert, cultured dairy dessert, ice cream, low-fat ice cream, non-fat ice cream, yoghurt, non-fat yoghurt, low-fat yoghurt, frozen yoghurt, non-fat frozen yoghurt, low-fat frozen yoghurt parfait, and the like.

In particular embodiments the thawed confection product may be for example yoghurt, or parfait.

In further particular embodiments the frozen confection product is an aerated confection product, in particular an aerated cold cultured dairy confection product, for example a frozen yoghurt. The frozen yoghurt of the invention may be full-fat, low fat or fat-free. In an embodiment of the invention, the frozen confection product normally comprises from 0.5% to 16% fat by weight. In another embodiment of the present invention, the low fat frozen or thawed confection comprises at most 5% fat.

In the context of the present invention, the term “fat” should be interpreted broadly and generally relates to one or more triglycerides independent of their melting temperature. The term “fat” comprises both triglycerides that are in liquid form at 25° C., as well as triglycerides that are in solid or semi-solid form at 25° C.

In the context of the present invention, the term “aerated” refers to a product which has air cells distributed evenly throughout the product. The air cells or air bubbles can be distributed throughout the product for example by extrusion or whipping air into the product, e.g. whipping of air into an ingredient mix. For example one volume part of air whipped into one volume part of ingredient mix is equal to 100% overrun, as described by Marshall, Goff and Hartel.

Overrun relates to the amount of air whipped in to an ingredient mix for preparing aerated products. Overrun is a term generally recognized for the skilled person within the field of frozen confection production and in the present invention overrun is defined as the increase in volume, in percentage, of frozen confection greater than the volume of the mix used to produce that frozen confection. In other words, if you start off with 1 litre of mix and you make 2.0 litres of e.g. frozen yoghurt from that, you have increased the volume by 100% (i.e., the overrun is 100%).

In an embodiment of the present invention, the product has an overrun of at least 20%, such as in the range of 20% to 150%, preferably in the range of 20-60%, even more preferably in the range 40-50%.

An advantage of overrun is that it makes the product scoopable even when frozen.

Thus, the invention also relates to a method wherein the freezing in step e) is in combination with aerating the mix to an overrun of at least 20%, such as in the range of 20% to 150%, preferably in the range of 20-60%, even more preferably in the range 40-50%.

The ingredient mix comprises one or more proteins, and may also comprise one or more of fat, sweeteners, stabilizers, emulsifiers. Further ingredients may be added to the ingredient mix, such as calcium. Alternatively, further ingredients such as flavouring and/or dyes may be added at other points in the method of producing the confection product.

### Protein

The invention also relates to a method wherein the ingredient mix comprises one or more proteins selected from dairy proteins, plant proteins or a combination thereof. Dairy proteins include milk proteins, for example caseins and whey proteins.

Examples of plant proteins include soya protein, pea protein, wheat protein, corn protein, rice protein, proteins from legumes, proteins from cereals and/or grains, protein isolates from nuts and/or seeds.

In an embodiment of the present invention, the protein is a dairy protein, for example from Milk-solid-non fats.

### Homogenizing

Homogenizing can be done either prior to or after pasteurization. It is preferably carried out under standard conditions, such as at a pressure of between 40 and 200 bars, preferably between 100 and 150 bars, more preferably between 120 and 140 bars.

### Pasteurization

The pasteurization step may for example be continuous or batch pasteurization. Continuous Pasteurization is performed under standard conditions and may be carried out prior to or after homogenisation. Preferred pasteurisation conditions include heating to a temperature in the range from 70 to 95° C. for from 30 to 120 seconds, such as 74 to 91° C. for 30 to 120 seconds, preferably 81-87° C. for 30 to 90 seconds. Other examples include heating to a temperature in the range from 75° C. to 90° C., such as from 80° C. to 90° C., even more preferably from 83° C. to 87° C. for a period of 30 to 120 seconds, preferably from 30 to 60 seconds.

Batch Pasteurization is preferably performed by heating to a temperature in the range from 69° C. to 85° C., such as in the range from 70° C. to 80° C. for a period of 30 to 120 minutes.

### Acidification

The method of the invention comprises acidification of the pasteurized ingredient mix to adjust the pH, after the pasteurization step, to a pH in the range from 4.0 to 6.5, preferably 4.6 to 5.0. In post-pasteurization acidification, the pH may for example be adjusted to a pH in the range from 4.0 to 6.5, or example 4.2 to 6.3, such as 4.3 to 6.0, such as 4.3 to 5.9, such as 4.3 to 5.5, such as 4.3 to 5.0, or for example 4.3 to 4.9.

As noted above, in a preferred embodiment, the method of the invention also comprises pre-pasteurization acidification.

Acidification may be achieved by any suitable means or combination of means. The pre- and post-pasteurization acidification steps may be achieved by the same means, or by differing means.

Preferably, the method of the invention relates to methods wherein acidification is achieved by a means selected from the group of: fermentation of a side culture and subsequent addition of the side to the ingredient mix, fermentation of the ingredient mix, and/or addition of one or more acids to the ingredient mix.

Acidification may for example be achieved by fermentation of a culture side whereby acidic metabolites are formed, and the subsequent addition of the side to the ingredient mix, i.e., addition of a fermentation product to the ingredient mix.

In another example, a culture may be added to the ingredient mix itself and fermented, i.e., fermentation of the ingredient mix.

In a further example, acidification may be achieved by the addition of one or more acids.

In a further example, combinations of one or more of these acidification means may be used.

A culture side typically comprises one or more microorganisms and a substrate which said microorganisms can metabolize. The microorganism produces acidic metabolites, which lower the pH of the culture side. When the culture side is added to the ingredient mix it will acidify the ingredient mix.

The microorganisms may be any suitable microorganism, but typically consists of one or more strains of bacteria. Preferably the bacteria comprise one or more species from Lactobacillus, Bifidobacterium, and/or Streptococcus thermophilus.

Examples of preferred bacteria include Lactobacillus bulgaricus, Lactobacillus acidophilus, Lactobacillus casei, Lactobacillus rhamnosus, Bifidobacterium species, Streptococcus thermophilus, and combinations thereof.

The microorganisms may be provided in any suitable form, such as for example in liquid, frozen or freeze-dried form.

In one embodiment the culture side comprises milk and a culture.

In one embodiment, the microorganisms are added to the ingredient mix, and the ingredient mix itself fermented.

The acidification may be achieved by addition of one or more acids. The acid may be selected from the group of liquid molasses, edible organic acids, fruit derived acids and fermentation derived acids. Examples of edible organic acids are lactic acid, acetic acid, formic acid, citric acid, oxalic acid and Glucono-delta-lactone. Examples of fruit derived acids include citric acid, malic acid and lactones. An example of fermentation derived acid is lactic acid.

In a preferred embodiment the acid is a weak acid. Examples of weak acids are glucono-delta-lactone, citric acid and lactic acid.

Strong acids have a pKa below 0.0. For example hydrochloric acid has a pKa of −7.0 and sulphuric acid has a pKa of −10.0. In contrast, weak acids have a pKa above 0.0 and preferably in the range of 2.5 to 7.0. For example acetic acid has a pKa of 4.74 and gluconic acid has a pKa of 3.70.

Glucono-delta-lactone and lactic acid are preferred for their mild taste.

Glucono-delta-lactone has a very slow hydrolysis to gluconic acid, which ensures a progressive and continuous decrease of pH to equilibrium, and therefore it is useful as a slow release acidifier. Moreover, during its hydrolysis, the initial sweet taste of Glucono-delta-lactone becomes only slightly acidic, making the final flavour of an aqueous solution of Glucono-delta-lactone much less tart than that of other acids.

In a particularly preferred embodiment therefore, acidification in the method of the invention comprises addition of Glucono-delta-lactone. In a further preferred embodiment, post-pasteurization acidification comprises addition of Glucono-delta-lactone.

The following Table 1 gives examples of specific embodiments of combinations of acidification means.

TABLE 1

| Pre-pasteurization | Post-pasteurization |
|---|---|
| acidification | acidification |
| Citric acid | Lactic Acid |
| Any acid, such as a weak | Glucono-delta-lactone |
| acid | |
| Glucono-delta-lactone | Lactic acid |
| Glucono-delta-lactone | Glucono-delta-lactone |
| Fermentation of culture | Glucono-delta-lactone |
| side and subsequent | |
| addition to ingredient mix | |
| Fermentation of ingredient | Glucono-delta-lactone |
| mix | |

The invention relates to a method, wherein one or more acidifying agents, selected from the group comprising one or more of a culture side, a fermentation product, a culture, a microorganism and/or an acid, is added in an amount of 0.05-20%, such as 0.1-15%, for example 0.1-9%, 0.1-8%, 1-8%, such as 1% to 7%, such as for example 2%-8%, such as for example 4-6%, such as for example about 5%.

In other embodiments said acidifying agent is added in an amount of for example 4-15%, such as 5-17%, 6-16%, 7-12% or 8-11%. Glucono-delta-lactone is an example of an acidifying agent which may be added at percentages above 5%.

The invention further relates to a method, wherein the weak acid, such as Gluconoe-delta lactone, lactic acid and/or citric acid, is added in an amount of 0.05-20%, preferably 0.1 to 2%.

### Freezing

In an embodiment the freezing step e) is performed by a standard continuous industry freezer, such as a Taylor freezer.

The invention also relates to a method of invention wherein a second freezing step is performed after the freezing step in e). The second freezing step may be for example a low temperature freezing (LTF) or a low temperature extrusion.

Low-temperature extrusion (LTE) is a known process which imparts to the final product a specific and advantageous microstructure. For instance, ice crystal size and air bubble size tend to be smaller than in traditional manufacturing processes. On the other hand, the size of fat globules does not change significantly when LTE process is used. Thus, the inclusion of a second freezing step, which is low temperature freezing, may further improve the texture of the frozen confection product.

One embodiment relates to method according to the invention, wherein the low temperature freezing is performed in a single or twin screw extruder.

In an alternative embodiment, LTE or LTF is not employed. The method of the invention leads to such a high degree of protein coagulation, that it is possible to produce very stable frozen confections with appealing texture, also without the use of LTE/LTF. The advantage of such an embodiment is procedural economy.

### Thawed Confection Product

In an embodiment the invention relates to a method of producing a confection product, comprising the step g) thawing the frozen confection product of the method, to form a thawed confection product.

The product of the method displays very good freeze-thaw stability, such that the frozen confection product may be thawed and served at temperatures where it is no longer frozen, with retained creamy texture.

This provides the consumer with flexibility and the choice of in what form to consume the frozen confection product.

### Products Obtainable by Methods of the Invention

The invention in another aspect relates to a frozen or thawed confection product obtainable by a method according to the invention.

The products obtainable by the method will contain ingredients in the ingredient mix, as well as any further ingredients added during the method.

### Ingredient Mix

The ingredient mix may besides protein also comprise one or more of fat, sweeteners, stabilizers, emulsifiers and calcium. In embodiments relating to cultured confection product, the ingredient mix may also comprise a culture.

The fat comprised in the ingredient mix may be from any source, such as derived from animal or from plants. In an embodiment the fat is derived from dairy, such as cream, butter, or milk. In a preferred embodiment the fat is milk fat, which adds flavour, color and body/texture to the frozen confection.

Alternatively the ingredient mix does not comprise fat from dairy but from plant sources. Such mixes are termed Mellorine mix and these mixes offer nutritional benefits such as lower saturated fats and lower cholesterol.

An embodiment relates to a method according to invention, wherein the ingredient mix comprises fat in an amount of 0-20% by weight, milk solid non-fat in an amount of 5-15% by weight, and a sweetening agent in an amount of 5-30% by weight.

The product of the invention may comprise fat in an amount of 0-20% by weight, such as for example 0-18%, 0-15%, 0-12%, 0-10%, 0-9%, 0-8%, 0-7%, 0-6%, 0-5%, 0-4%, 0-3%, 0-2%, 0-1%, or 0-0.5%; or for example 3-15%, 4-12%, 5-12%, all percentages by weight. In a preferred embodiment the product of the invention does not comprise fat. In a further preferred embodiment the product of the invention is essentially fat-free.

### Sweeteners

The product of the invention may comprise one or more sweeteners. Sweeteners refer to an ingredient or mixture of ingredients which imparts sweetness to the final product. These include natural sugars such as cane sugar, beet sugar, molasses, other plant-derived nutritive sweeteners, and non-nutritive high intensity sweeteners.

### Stabiliser System

The product of the invention may comprise a stabiliser system. Stabiliser system refers to one or more ingredients which contribute to the stability of the frozen product with respect to ice crystal formation, heat shock resistance, overall texture properties etc. Thus, the stabiliser system may comprise any ingredients which are of structural importance to the frozen confection product.

In an embodiment the stabiliser system consists of natural ingredients.

The product of the invention may include a natural stabiliser system such as those described in application EP08171666.4, the entire content of which is expressly incorporated herein by reference hereto.

In a preferred embodiment the product of the invention does not comprise a stabiliser system. In another embodiment the product of the invention used does not comprise emulsifiers. In a further embodiment, the product of the invention mix does not comprise stabilizers or emulsifiers. In a yet further preferred embodiment, the product according to the invention is essentially or completely free from artificial or non-natural emulsifiers or stabilizer.

The term “natural ingredients” refer in the context of the present invention to ingredients of natural origin. These include ingredients which come directly from the field, animals, etc. or which are the result of a physical or microbiological/enzymatic transformation process. These therefore do not include ingredients which are the result of a chemical modification process.

Examples of artificial and non-natural ingredients which are avoided in a particular embodiment of the invention include for example the following emulsifiers; mono- and diglyceride of fatty acids, acid esters of mono- and diglycerides of fatty acids such as acetic, lactic, citric, tartaric, mono- and diacetyl tartaric acid esters of mono- and diglycerides of fatty acids, mixed acetic and tartaric acid esters of mono- and diglycerides of fatty acid, sucrose esters of fatty acids, polyglycerol esters if fatty acids, polyglycerol polyricinoleate, polyethylene sorbitan mono-oleate, polysorbate 80 and, chemically extracted lecithins.

The term “artificial emulsifiers” may also be referred to as synthetic emulsifiers or non-natural emulsifiers and the terms may be used interchangeably.

Chemically modified starches which are used in the art as stabilizers are also preferably avoided. These include for example modified starch, monostarch phosphate, distarch phosphate, phosphate or acetylated distarch phosphate, acetylated starch, acetylated distarch afipate, hydroxyl propyl starch, hydroxypropyl distarch phosphate, acetylated modified starch.

The products of the present invention are preferably essentially free of the preceding synthetic esters and modified starches.

“Essentially free” means in the context of the present application, that these materials are not intentionally added for their conventional property imparting abilities, e.g. stabilizing, although there could be unintended minor amounts present without detracting from the performance of the products. Generally and preferably, the products of the invention will not contain any non-natural materials.

By the term “essentially or completely free” is therefore meant that the product comprise 1% or less of a given compound.

In an embodiment the product of the invention has a pH of from 4.0 to 6.5, such as for example from 4.5 to 6.0, such as from 4.5 to 6.0, for example 4.6 to 5.8; or for example from 4.6 to 5.0, or for example 4.3 to 5.0. Preferably the pH is from 4.6 to 5.0.

As noted above, products of the invention comprise an essentially completely coagulated protein network comprising aggregates.

In the context of the invention, particle size of aggregates is meant to designate their surface area mean diameter or the Sauter mean diameter (D[3,2]). The percentage in volume of those aggregates with a D[3,2] comprised in the range from 2.28 and 100 microns is for example above 10%, such as above 20%, for example 40%, above 50%, above 60%. Preferably said volume is above 70%, such as above 80%. In preferred embodiments said volume is in the range from 50 to 95%, such as from 60 to 90%.

Said aggregates are preferably formed in situ during the processing of a frozen confection ingredient mix comprising from 0.5 to 20 wt % fat, from 5 to 15 wt % milk solids-non-fat, from 5 to 35 wt % sweetening agent, up to 6 wt % of stabilizer and up to 0.5 wt % of a natural emulsifier comprising acacia gum. In particular, they are obtainable by adjusting the pH of such a frozen confection ingredient mix to a value comprised in the range from 4.0 to 5.0 after pasteurization.

In an embodiment the product according to invention, the product comprises total solids of 30% or more. Inclusion of solids over 30% can increase stability of the product. Thus the totals solids may for example be over 30%; such as over 40%, over 50%, over 60%. Preferably, the total solids in the product of the invention are from 30 to 40%, even more preferably from 35% to 40%.

It should be noted that embodiments and features described in the context of one of the aspects of the present invention also apply to the other aspects of the invention.

All patent and non-patent references cited in the present application, are hereby incorporated by reference in their entirety.

The invention will now be described in further details in the following non-limiting examples.

### EXAMPLES

The following examples are provided to illustrate the invention and are not intended to limit the scope of the invention.

### Example 1

### A Frozen Confection Prepared by a Method Comprising Only Pre-Pasteurization Acidification

TABLE 2

| Ingredient | Wt % of final product |
|---|---|
| Fat | 5.5 |
| Sugar | 10-12 |
| MSNF | 9-11 |
| Corn Syrup | 6-8 |
| Acacia gum | 0.1-0.3 |
| Natural Stabilizer | 0.5 |
| Total Solids | 30-35 |

The frozen confection product was prepared according to the following:

An ingredient mix comprising an ingredient mix comprising 11 wt % fat, from 10-12 wt % milk solids-non-fat, from 18-22 wt % sweetening agent, up to 6 wt % of stabilizer and up to 0.5 wt % of a natural emulsifier comprising acacia gum was provided.

The ingredient mix was acidified by addition of citric acid at 0.05% by weight to reduce pH to 5.6-6.3. The acidified mix was then homogenized at a stage one at 1500 psi and at stage two at 500 psi and subsequently pasteurized at 82° C. for 90 seconds. The pasteurized mix was then frozen by using a combination of a standard continuous industry freezer and low temperature freezing.

### Example 2

### A Frozen Confection Product Prepared by a Method Comprising Both Pre- and Post-Pasteurization Acidification

TABLE 3

| Ingredient | Wt % of final product |
|---|---|
| Fat | 4.3 |
| MSNF | 9-12 |
| Sugar | 8-10 |
| Corn Syrup | 5-7 |
| Stabilizer | 0.5-0.7 |
| Total Solids | 34-40 |

The frozen confection product was prepared by mixing the ingredients mentioned above and then add 0.05% by weight citric acid to reduce pH to 5.6-6.3, or 5.8-6.2. The acidified ingredient mix was then homogenized at stage one at 1500 psi and at stage two at 500 psi and subsequently pasteurized at 82° C. for 90 seconds. The pasteurized mix was then further mixed with lactic acid at 0.5%, this is the post-pasteurization acidification step. After acidification, the mix was frozen by using a combination of a conventional freezer and a low temperature freezing.

### Example 3

### A Frozen Confection Product Prepared by a Method Comprising Post-Pasteurization Acidification Only

TABLE 4

| Ingredient | Wt % of final product |
|---|---|
| Fat | 4.3 |
| MSNF | 9-12 |
| Sugar | 8-10 |
| Corn Syrup | 5-7 |
| Stabilizer | 0.5-0.7 |
| Total Solids | 34-40 |

The frozen confection product mix was homogenized at stage one at 1500 psi and at stage two at 500 psi and subsequently pasteurized at 82° C. for 90 seconds. The pasteurized mix was then further mixed with lactic acid at 0.5%, this is the post-pasteurization acidification step. After acidification, the mix was frozen by using a combination of a conventional freezer and a low temperature freezing.

### Example 4

### Method of Preparing Optical Microscope Pictures of Sample Frozen Confection Products

Microscope: Zeiss Axioplan 2 with differential interference contrast (DIC) optics and 10× and 40× objectives
Buffered stain solution: Toluidine blue, 0.04% by weight dissolved in pH 7.0 calibration buffer (phosphate) from VWR and filtered with coarse filter paper

Mixed approximately 0.15 g of the sample (mix or frozen product) dispersed in 9 parts by weight of the buffered stain solution in a small weighing dish. Stirred with transfer pipette until uniform. After approximately 1 minute, stirred again and added 2 drops of the stained sample to a 25×75 mm microscope slide, and covered each drop with a 22 mm square cover glass.

Captured 40 images (20 from each drop) with the 10× objective (approximately 100× effective magnification), moving about 2 mm between captures. Then selected a representative field and switched to the 40× objective, capturing images while adjusting the focal depth to view the detail from the top layer (large fat droplets) to the bottom layer (sediment).

### Example 5

### A Comparative Study of Frozen Confection Product Prepared by a Pre-Pasteurization Acidification Method and a Pre- and Post-Pasteurization Acidification Method Respectively

In this study the frozen confection product of Examples 1 and 2 are compared.

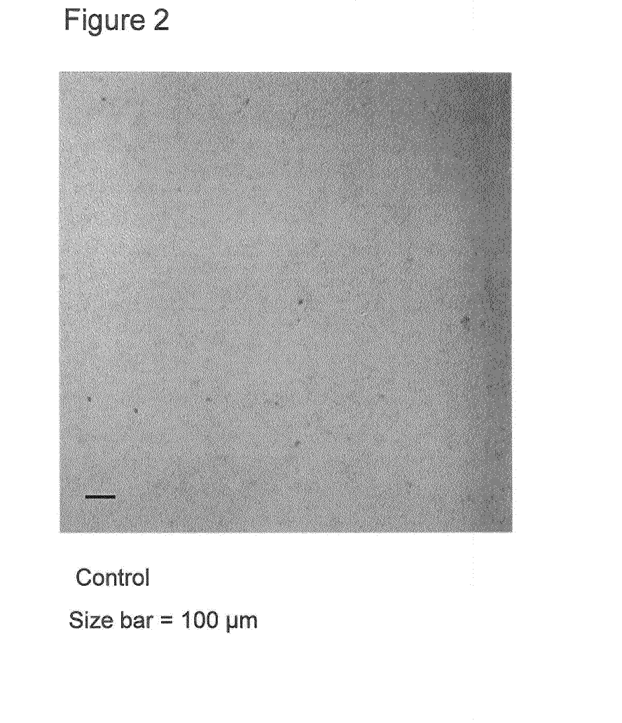

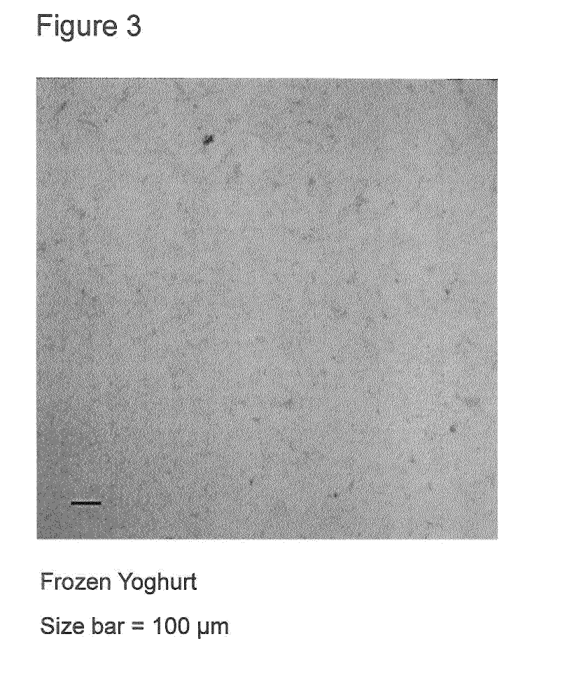

Microscopy pictures of both frozen confection products have been made, and are shown in FIGS. 2 and 3 respectively. FIG. 2 shows a microscopy picture of a frozen confection product prepared by a method comprising only pre-pasteurization acidification (i.e. no post-pasteurization acidification). FIG. 2 shows a microscopy picture of a frozen confection product prepared by a method comprising both pre- and post-pasteurization acidification.

The pictures show the presence of protein aggregation in the samples of frozen dairy desserts using Toluidine Blue stain. The Frozen yoghurt (FIG. 3) displays protein structures that are more fibril like and forming a large network, while the Control (FIG. 2) displays protein clusters that are bigger, more round shaped and separated from each other.

### Example 6

### Volume-Based Particle Size Distribution and Volume Mean Diameter

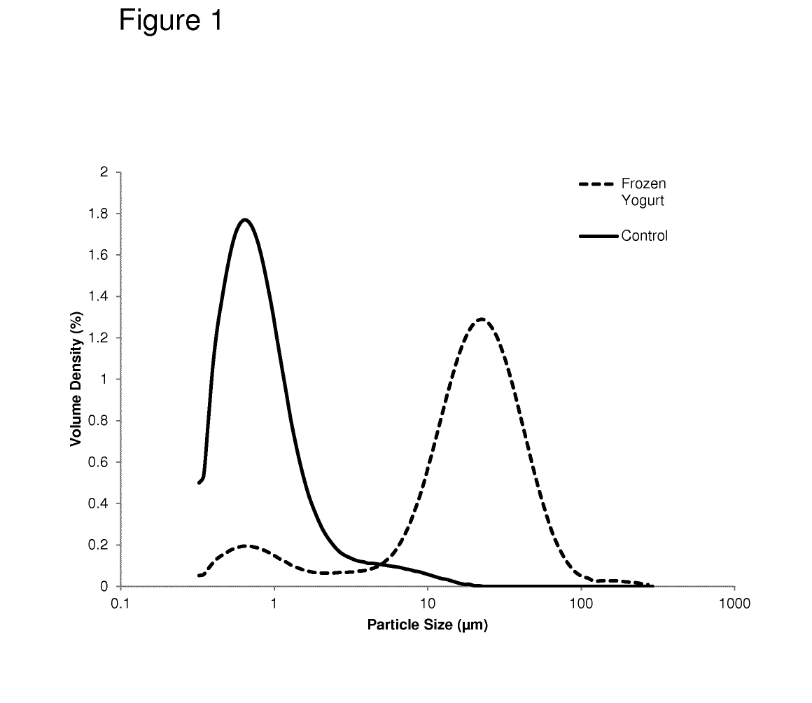

See also FIG. 1

The difference in frozen confection products obtained by a process with only pre-pasteurization acidification, and those produced by a method comprising both pre- and post-pasteurization acidification respectively have been evaluated by measuring particle volume distribution with a laser diffraction particle size analyzer.

Particle size distribution is measured by diluting approximately 2.5 g mix or frozen product in 10 parts by weight de-ionized water (approx. 25 g) and mixed until uniformly distributed. If frozen, the product will melt during this step.

Stirring rate is set to 1600 rpm. The diluted mixture is then added slowly to the dispersion module of the particle size analyzer until the optimal concentration is reached, as indicated by the degree of light obscuration (17-20%). The sample is allowed to circulate through the measuring system for an additional 30 seconds before starting the measurement.

FIG. 1 shows the particle size distribution of a sample prepared by pre-pasteurization acidification (Control) as compared pre- and post-pasteurization acidification (Frozen Yoghurt). The peak of Frozen yoghurt is representative of the protein aggregates.

In the below table, the volume fraction (%) of fat droplets and clusters whose diameter is above 2.28 μm is an indication of fat clustering. Also shown is the volume-based mean diameter of the fat droplets and clusters from a sample of a frozen confection product of the invention (pre and post pasteurization acidification, Frozen Yoghurt) compared to a product from a process comprising only pre-pasteurization acidification (Control).

TABLE 5

| | Volume fraction | Vol. mean |
|---|---|---|
| Product | (%) >2.28 μm | Diameter (μm) |
| Control | 8.09 | 0.72 |
| Frozen | 89.20 | 5.08 |
| Yoghurt | | |

From the above table it may be concluded that the volume fraction above 2.28 μm diameter and volume mean diameter of a product prepared by post pasteurization acidification is much larger than when using pre- and post-pasteurization acidification. This indicates that more protein is getting aggregated and coagulated in Frozen Yoghurt as compared to the Control. Thus an improved network is obtained in products obtained by the post-pasteurization method as compared to the pre- and post-pasteurization method.

### Example 6

### Examples of Methods of the Invention

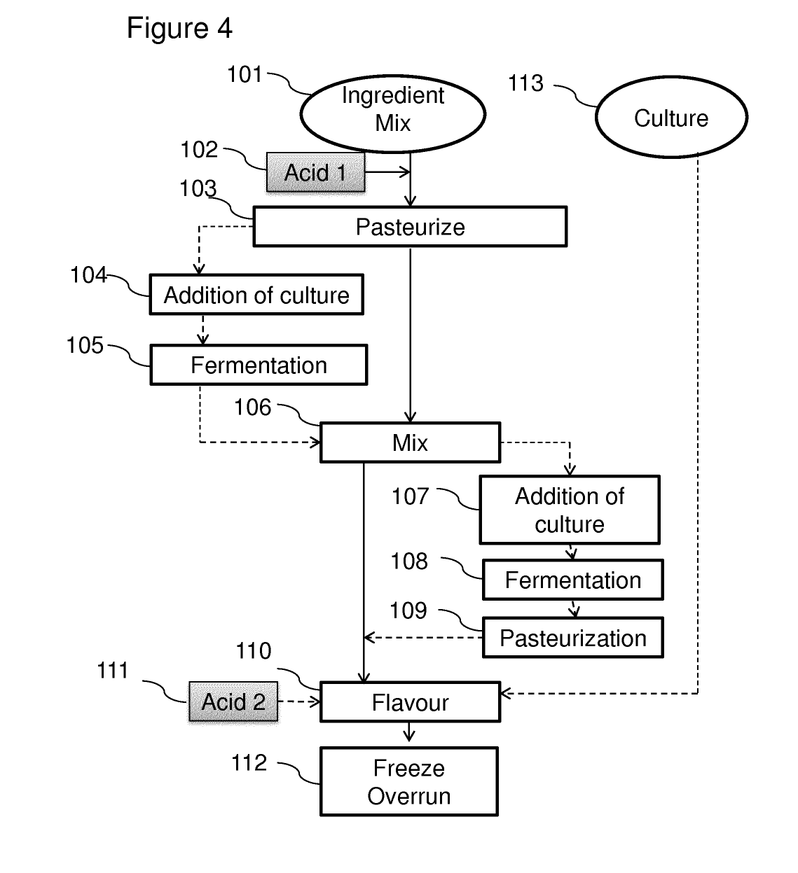

FIG. 4 illustrates examples of methods of the invention.

The ingredient mix (101) is provided. The ingredient mix (101) may be acidified in an optional pre-pasteurization acidification step. In this flow chart an acid is added (102, Acid 1). However, in other embodiments acidification may be achieved by for example by fermentation, or the addition of a fermented culture.

After pasteurization (103), the examples of the method describe four exemplary paths, described below.

In one method the pasteurization step (103) is followed directly by mixing (106). After mixing (106), flavours and colorants are added (110). At the same time as flavour is added, a second acidification step is performed by the addition of Acid 2 (111). Acid 2 may be the same acid as in Acid 1, or they may be different. This is followed by freezing and addition of overrun (112).

In a second alternative method, the pasteurization step (103) is followed by addition of a culture (104) and fermentation takes place (105). Subsequently mixing (106) is performed, after which flavour is added (110). In this example, acidification is performed by fermentation (105). This is followed by freezing and addition of overrun (112).

In a third alternative, the pasteurization step (103) is followed directly by mixing (106). After mixing (106), a culture is added (107) and fermentation takes place (108). This is followed by a pasteurization step (109). Subsequently, flavour is added (110), followed by freezing and addition of overrun (112).

In a fourth alternative, the pasteurization step (103) is followed directly by mixing (106), which in its turn is followed directly by addition of flavour and colorants (110). At the same time as flavourings are added, a fermented culture (113) is added. In this example, acidification is performed by addition of a fermented culture (113). This is followed by freezing and addition of overrun (112).

1. A method of producing a confection product, comprising the steps of
a) providing an ingredient mix comprising one or more proteins;
b) homogenizing the ingredient mix;
c) pasteurising the ingredient mix;
d) acidification of the pasteurized ingredient mix to adjust the pH to a pH in the range from 4.0 to 6.5; and
e) freezing the pasteurized and acidified mix to form a frozen confection product.

2. The method according to claim 1, comprising the step of acidification of the mix before pasteurization in step c).

3. The method according to claim 1, wherein the one or more proteins are selected from the group consisting of dairy proteins, plant proteins and combinations thereof.

4. The method according to claim 1, wherein acidification is achieved by a means selected from the group consisting of: fermentation of a side culture and subsequent addition of the side to the ingredient mix, fermentation of the ingredient mix, and/or addition of one or more acids to the ingredient mix.

5. The method according to claim 4, wherein acidification is by addition of a weak acid.

6. The method according to claim 5, wherein the weak acid is glucono-delta-lactone.

7. The method according to claim 5, wherein the weak acid is added in an amount of 0.05-20%.

8. The method according to claim 1 wherein the freezing in step e) is in combination with aerating the mix to an overrun of at least 20%.

9. The method according to claim 1, wherein the ingredient mix comprises fat in an amount of 0-20% by weight, milk solid non-fat in an amount of 5-20% by weight, and a sweetening agent in an amount of 5-30% by weight.

10. The method according to claim 1, comprising the step of adding a component selected from the group consisting of flavors, colorings, further proteins, water and combinations thereof.

11. A frozen or thawed confection product obtainable by the method according to claim 1.

12. The product according to claim 11, wherein the pH of the final product is from 4.0 to 6.5.

13. The product according to claim 11, wherein the product is selected from the group consisting of ice cream, non-fat ice cream, low fat ice cream, frozen yoghurt, dairy dessert and cultured dairy dessert.

14. The product according to claim 11, wherein the product is completely free from artificial or non-natural emulsifiers or stabilizer.

15. The method of claim 1 including the steps of hardening the product from step e); and
thawing the product to form a thawed confection product.
